(19) United States
(12) Patent Application Publication
(10) Pub. No.: US 2023/0104661 A1
(43) Pub. Date: Apr. 6, 2023

(54) SYSTEM AND METHOD FOR IMPROVING E-COMMERCE

(71) Applicant: ADEPTMIND INC., Toronto (CA)

(72) Inventors: Zhiyuan WU, Toronto (CA); Jing HE, Oakville (CA); Sebastian BULZAK, Toronto (CA); Sebastian REGALADO, Toronto (CA); Ryan WILSON, Toronto (CA); Mohamed METWALY, Toronto (CA)

(21) Appl. No.: 17/937,903

(22) Filed: Oct. 4, 2022

Related U.S. Application Data
(60) Provisional application No. 63/252,354, filed on Oct. 5, 2021.

(51) Int. Cl. G06Q 30/0251; G06Q 30/0241

(52) U.S. Cl. CPC G06Q 30/0253; G06Q 30/0276; G06Q 30/0256; G06Q 30/0246

(57) ABSTRACT

A method and system for improving e-commerce that is directed at improving landing pages for consumer products. Using long tail query phrases, the method and system generates more detailed landing pages that will assist in providing more information to consumers.

### CROSS-REFERENCE TO OTHER APPLICATIONS

The disclosure claims priority from U.S. Provisional Patent Application No. 63/252,354 filed Oct. 5, 2021, which is hereby incorporated by reference.

### FIELD

The disclosure is generally directed at e-commerce, and, more specifically, at a system and method for improving electronic commerce (e-commerce).

### BACKGROUND

In the world of e-commerce, the ability to display and sell goods is paramount. By having a website that is informative and provides relevant information to buyers is a benefit to e-retailers. Currently, product listing pages provide limited information to buyers and require the buyers to take further action in order to access product detail pages.

These further actions may require users to click to other webpages or websites which may be both time consuming and be annoying to users. Instead of making a purchase, the users may decide to forego the purchase since they are being required to do more clicking especially when the user is trying to look at new products to purchase. This takes away from a company's ability to make sales.

Therefore, there is provided a novel system and method for improving e-commerce.

### SUMMARY

The disclosure is directed at improving e-commerce by generating landing pages that are improvements over current landing pages.

In one aspect of the disclosure, there is provided a method of generating a dynamic landing page for a product for purchase for e-commerce including generating an initial page for the product for purchase based on a query phrase; inserting selected text based on the query phrase; associating selected text with products; and obtaining ads based on the generated website.

In another aspect, generating an initial page based on a query phrase includes generating a long tail query phrase as the query phase. In a further aspect, generating a long tail query phrase includes receiving a cluster input; appending a product name to the cluster input to produce the query phrase; associating consumer products associated with the query phrase; and validating the query phrase; wherein the query phrase is a long tail query phrase. In yet another aspect, the method includes generating at least one of a traffic or product quality score for the query phrase. In yet another aspect, the method includes, before receiving the cluster input, retrieving unstructured or structured text associated with the product for purchase; processing the unstructured or structured text to generate a product for purchase topic; retrieving other topics associated with the product for purchase topic; aligning unstructured or structured text with the product for purchase; and naming a combination of the unstructured or structured text, the product for purchase, the product for purchase topic and the optics associated with the product for purchase topic as the cluster input. In yet a further aspect, the method further includes storing the combination of the unstructured or structured text, the product for purchase, the product for purchase topic and the optics associated with the product for purchase topic as the cluster input. In another aspect, processing the unstructured or structured text includes processing the unstructured or structured text via topic modeling.

In another aspect, the method includes, before generating an initial page based on a query phrase tracking keywords associated with the product for purchase, where tracking keywords includes performing an initial of the keywords; generating at least one query phrase in the form of a set of landing page candidates. In another aspect, tracking keywords associated with the product for purchase includes scraping website search result pages. In yet another aspect, the method includes performing at least one further validation of the keywords if the initial validation does not meet a predetermined level. In yet another aspect, performing at least one further validation of the keywords comprises at least one of performing a validation based on keyword volume; performing a validation based on a level of traffic the keywords have on search engines; performing a validation based on keyword relevance; or performing a validation based on keyword deduplication.

### BRIEF DESCRIPTION OF THE DRAWINGS

Embodiments of the present disclosure will now be described, by way of example only, with reference to the attached Figures:

FIG. 1 is a schematic diagram of an e-commerce environment;

FIG. 2 is a schematic diagram of a system for e-commerce;

FIG. 3 is a flowchart outlining a method of extracting user intent data in accordance with the disclosure;

FIG. 4 is a flowchart of generating a long tail query in accordance with the disclosure;

FIG. 5 is a flowchart of a method of generating a dynamic product listing page in accordance with the disclosure;

FIG. 6 is an example of dynamic producing listing page generated via the method of FIG. 5; and

FIG. 7 is a flowchart showing another method of improving e-commerce.

### DETAILED DESCRIPTION

The disclosure is directed at a system and method of improving e-commerce. In one embodiment, the disclosure is directed at a method for generating landing pages for e-commerce. In another embodiment, the disclosure provides an improvement with respect to e-commerce sales pages where the generated sales pages include more relevant information relating to sales produces.

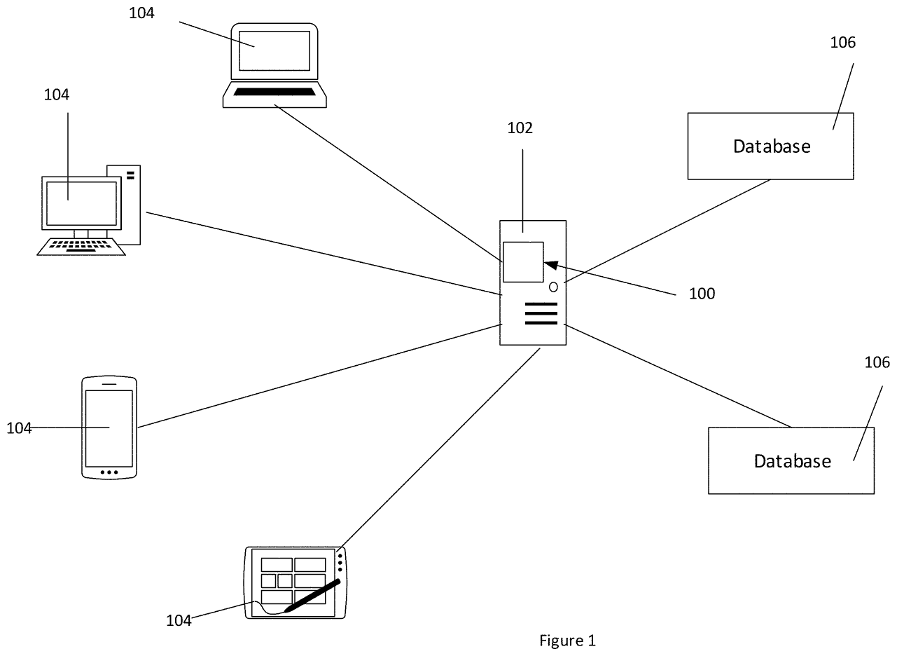

Turning to FIG. 1, a schematic diagram of an e-commerce environment is shown. In the current embodiment, the system for improving e-commerce 100 is stored in a server 102 that is communicatively connected to users (via user devices 104) and to information repositories or databases 106, such as, but not limited to, at least one database storing customer reviews. These information repositories may be associated with the system or belong to external parties that control that specific information repository. Examples of user devices 104 that can communicate with the system 100 include, but are not limited to, tablets, smartphones, laptops, desktop computers and the like. Communication between the system for improving e-commerce 100, the user devices 104 and the database will be understood by one skilled in the art.

In operation, the users, via their user devices, may connect to the server to access the system for improving e-commerce. In one embodiment, the system may then communicate with the user device to provide, or transmit, a dynamic product listing page, where a user can review the dynamic product listing page. In one embodiment, the dynamic product listing page may be seen as a product listing page that includes excerpts from reviews of products shown on the dynamic product listing page.

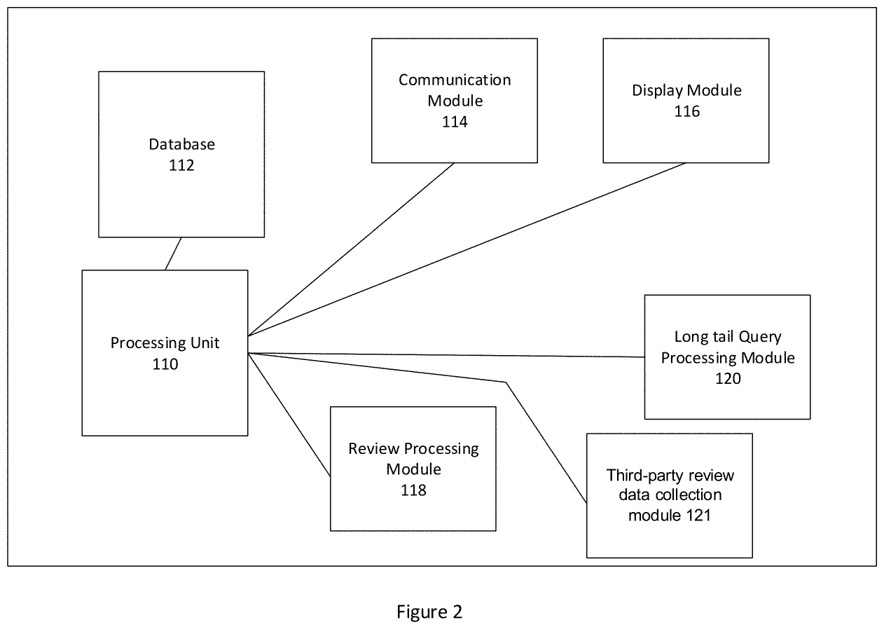

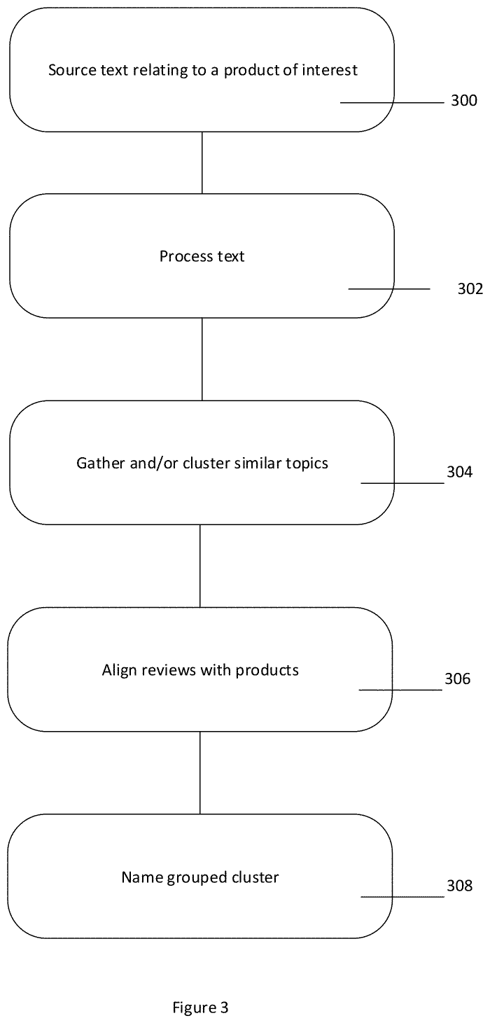

Turning to FIG. 2, a schematic diagram of one embodiment of the system is shown. In the current embodiment, the system 100 may include a processing unit 110 that processes data and assists to perform various methods of the disclosure, such as those disclosed below. The system 100 may further include a database 112 for storing information that is either processed, generated or retrieved by the system 100 (or processing unit 110). In order to execute or perform methods of the disclosure, the system 100 may further include a communication module 114 that enables the system to communicate with the user devices 104, the information repositories 106 or other servers and/or devices (not shown) and a display module 116 that generates displays for displaying on the user devices 104 or any other displays. The system 100 may further include a review processing module 118 that parses customer reviews of different items or products that are retrieved by the system. The review processing module 118 may also assist, or may, perform a method of extracting customer intent such as disclosed with respect to FIG. 3. The system 100 may further include a long tail query processing module 120 that, in one embodiment, provides a naming convention to data that has been retrieved and/or processed by the reviewing processing module 118. The system 100 may also include a third-party review data collection module 121 that processes and/or downloads related review data or information from other servers or databases.

Turning to FIG. 3, a flowchart outlining a method of extracting customer intent data from unstructured text via topic modeling is shown. In one embodiment, the method of FIG. 3 may be used to assist in improving e-commerce. By extracting customer intent data, an improved product listing page may be provided to buyers to assist them in purchasing items. In one embodiment, the improved, or dynamic, product listing page includes reviews of products that have been previously submitted by other individuals who are familiar with the product being listed.

Initially, the system sources, retrieves or obtains unstructured or structured text relating to a product of interest, such as in the form of customer reviews or product descriptions by the manufacturer or seller (300). In one embodiment, the system sources only unstructured text. Typically, this is performed using information or input different online sources (or information repositories) within a specific product segment such as, but not limited to, beauty products or home furnishings. Online sources may include, but are not limited to, other e-commerce sites, online description of products and/or social media posts relating to the product. In some embodiments, the system may also source manually labeled product attributes.

In one embodiment, in order to source and/or retrieve the customer reviews, the system 100 may communicate, via the communication module 114, with the information repositories, or databases, to retrieve the desired material. In another embodiment, the customer reviews are in unstructured text, such as paragraphs, whereby this unstructured text may be more easily processed by the system 100.

For instance, one example of unstructured text relating to a curling iron may be the paragraph “A quick YouTube search and I figured out how to use it the best way! It doesn't tug my hair, you'll probably never get burned using it and the color is beautiful. The bad reviews definitely should've researched more, because this is my favorite tool ever!”

After receiving the customer review, or customer review text, or unstructured text, the system then processes the text (302). In one embodiment, the text may be processed via topic modeling.

In one embodiment, the system processes the text to retrieve or obtain relevant comments, or phrases, about the selected product (for instance, a curling iron). As one example, phrases, or topics, such as “doesn't tug my hair”, “never get burned using it”, “color is beautiful” or “favorite tool” in the customer review, or reviews, may be retrieved by the system. One advantage with respect to the disclosure is the ability to perform open topic modeling accurately using the method of FIG. 3. More specifically, the system performs open topic modeling in an interactive and semi-supervised manner so that the system may scale to a larger number of topics, maintain high level of accuracy and/or use a minimal or low amount of human labeling effort. Open topic modeling may be defined as a process where the system, such as via artificial intelligence (AI), is able to extract a given topic (or text string relating to a given topic) from the unstructured text (such as the customer reviews) without having any previous clues, indication, or input, about or with respect to that topic. This is different from closed topic modeling which means the Al is only able to extract topics if the customer reviews contain certain previously known, searched, predetermined, or requested keywords.

After processing the text via open topic modeling, the system then gathers all the topics and clusters topics with similar meanings (304). For instance, topics or phrases such as “never get burned using it”, “it probably won't burn you”, “it won't burn your hair” and/or “no burn” may be grouped together in a single cluster. This process may also be seen as topic embedding. In one embodiment, the clustering, or topic embedding, is performed via multiple iterations whereby, for each iteration, the system, or model, filters out the text related to existing covered topics, so that an increased level of granularity with respect to topics can be exposed or obtained.

The system may then align the sourced text, which in the current example is customer reviews, with their associated product (306) so that the extracted review excerpts may be associated with the correct products when displayed (as will be discussed below). This alignment is performed at any point and does not have to be performed after the processing of text via open topic modeling but may be performed before. The grouping may then be named and stored (308). In one embodiment, the name of the grouping may be selected by picking a concise topic or phrase within the cluster like “no burn”, may be assigned a name based on a similarity between all the phrases or may be assigned randomly. This grouping may be seen as an extraction of customer intent data from unstructured text. The extraction of the customer intent data from unstructured text may then be used to generate improved, or dynamic, product landing pages as will be discussed in more detail below. The method of FIG. 3 may be performed or executed to generate any number of groupings or clusters.

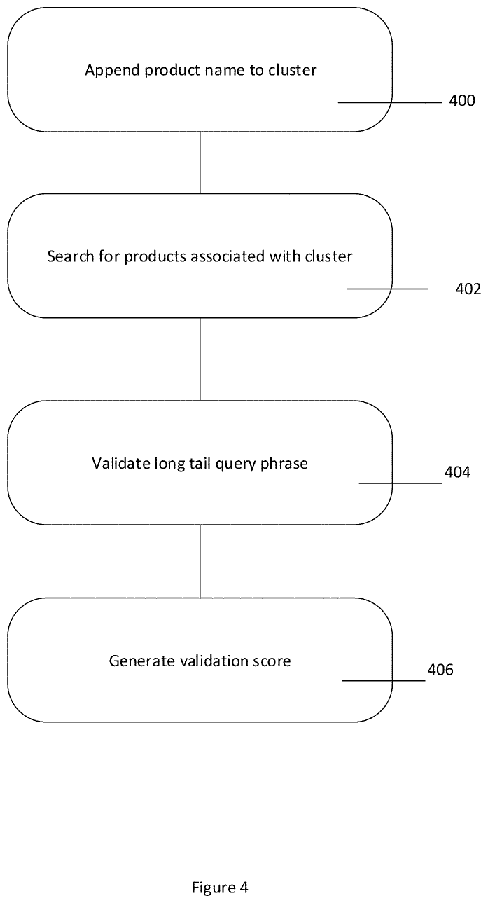

Turning to FIG. 4, a flowchart outlining a method of generating a long tail query is shown. In the following description, the focus is with respect to a single grouping but it is understood that the same methodology may be performed or apply to any number of groups generated by the system, either via the method of FIG. 3 or via other known methods. A long tail query may be seen as a query that relies on words or phrases that are more specific, and typically longer than three words.

Initially, taking advantage of the cluster (or grouping) that was generated by the method of FIG. 3, the cluster may be amended to append or include a product name to the name of the cluster (400) to generate a query phrase. For example, if the cluster was named “no burn” and the product is a curling iron, the result of the amendment may produce the phrase, or long tail query phrase, “no burn curling iron”. Once the query phrase is generated, a search is performed to associate consumer products that are, or may be, seen as a “no burn curling iron” (402). This may be performed by executing online searches for products that may be classified or categorized as a “no burn curling iron”. In one embodiment, the system may access a product database to perform a search using keywords such as, but not limited to, combinations of the words “no burn”, “curling”, and “iron”.

The relevant products may then be grouped for display, such as on a product listing page, and associated with the long tail query phrase. Combining the cluster or grouping, or cluster/grouping information that was located using review data (such as taught in FIG. 3) to generate the long tail query phrase is novel and provides an advantage over current search systems. Alternatively, other expressions or versions of the cluster name, or product name may be used and does not have to match the exact long tail query phrase.

After collecting or retrieving the consumer products grouping, the long tail query phrase may then be validated (404). This may be performed by data mining the query phrase or by trying to determine how often the long tail query phrase (or a large portion of the phrase) can be found online. In one embodiment, the comparison is an exact word for word comparison. In another embodiment, the comparison is at least half of the words in the same position where curling is before iron and not the words or phrase “iron curling”.

After validating the long tail query phrase, a traffic score and a product quality score (seen collectively as a validation score) may be generated for each query phrase (406). The traffic score may represent how much traffic the long tail query phrase will generate while the product quality score may represent a number of products a retailer has matching this query phrase. In one embodiment, each product (relating to the query phrase) is matched against the query phrase, and each product receives a relevance score. If the number of products that receive a suitable relevance score passes a threshold, the long tail query phrase receives a good product quality score. After that, query phrases that receive both a good quality score and a good traffic score are selected.

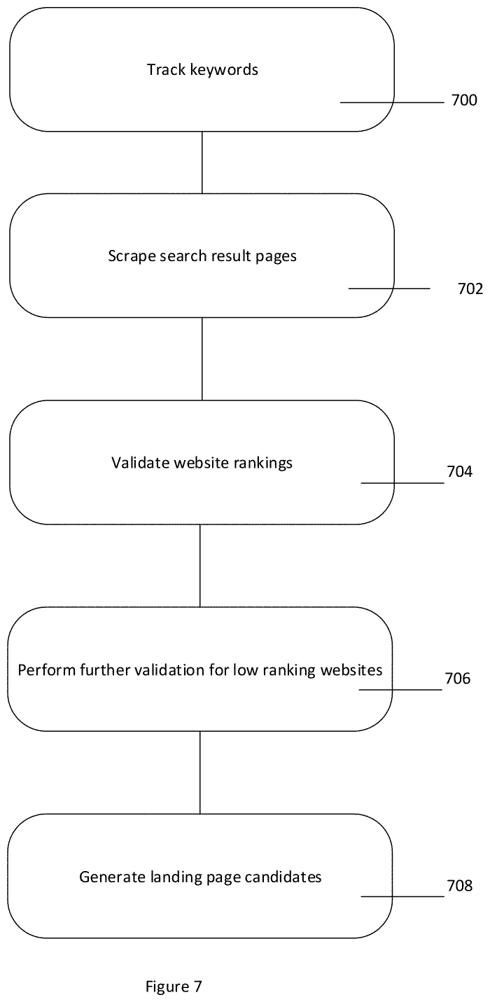

Turning to FIG. 7, a flowchart showing another embodiment of a method for improving e-commerce is shown. The method of FIG. 7 combines the methods of FIGS. 3 and 4. The current method may be executed in place of the methods of FIGS. 3 and 4 for the overall disclosure.

Initially, the system may track all keywords that are relevant to a product in relation to a specific website (700). In one embodiment, this may be performed using a system that is able to combine keyword searches with online rankings (relating to search volume and other website analytics). This part of the method may represent what was performed in FIG. 3.

In another embodiment of (700), the system may then scrape search result pages (i.e. from different search engines) to validate where the specific website ranks in relation to the tracked keywords (702). Alternatively, the system may communicate with an external component that performs this scraping. For the keywords that do not rank well in relation to the website ranking, in order to improve the landing page, further validation may be performed by the system (706). Some examples of further validation may include validation of keyword volume or validation or how much traffic the keyword has on various search engines. Another type of validation may be keyword relevance which may be used to determine does a certain website have enough products relating to the keyword to achieve the amount of traffic for the landing page to be of interest. Another type of validation may be keyword deduplication which checks to see if the website already had a landing page that is semantically similar to the keyword (for example: laptops vs new or best laptops).

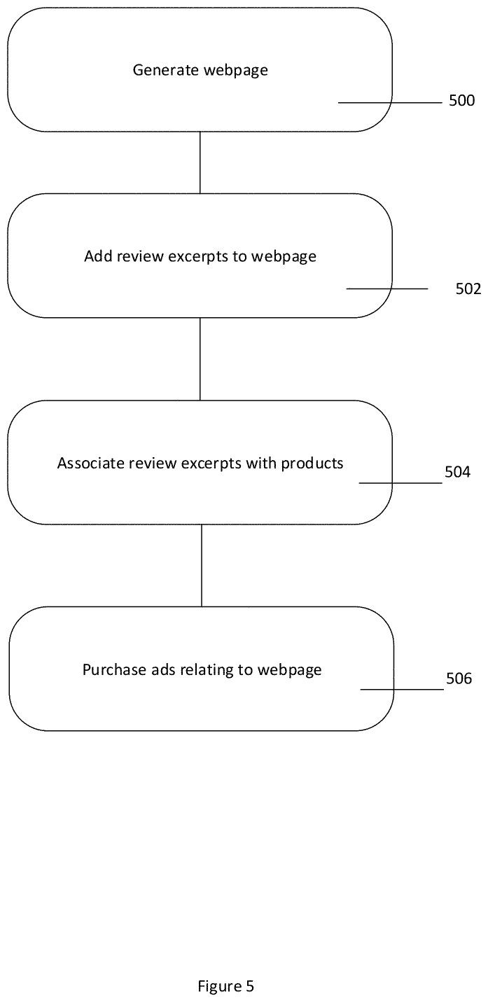

After validation, the system may then generate or create landing page candidates (708) which may be used as input for the method taught in FIG. 5 below. By taking advantage of current web ranking systems, the method of FIG. 7 may be seen as an alternative to the individual methods of FIGS. 3 and 4.

Turning to FIG. 5, a flowchart outlining a method of generating a dynamic landing page is shown. In one embodiment, the method of FIG. 5 involves the query phrase that was generated in the method with respect to FIG. 4 or the results from the method of FIG. 7. The following description of FIG. 5 is directed at a single query phrase, however, it is understood that the method may also be performed for each of the long tail query phrases that are generated by the method of FIG. 4. In other embodiments, the method of FIG. 5 may only be performed on, or for, selected, or predetermined, query phrases.

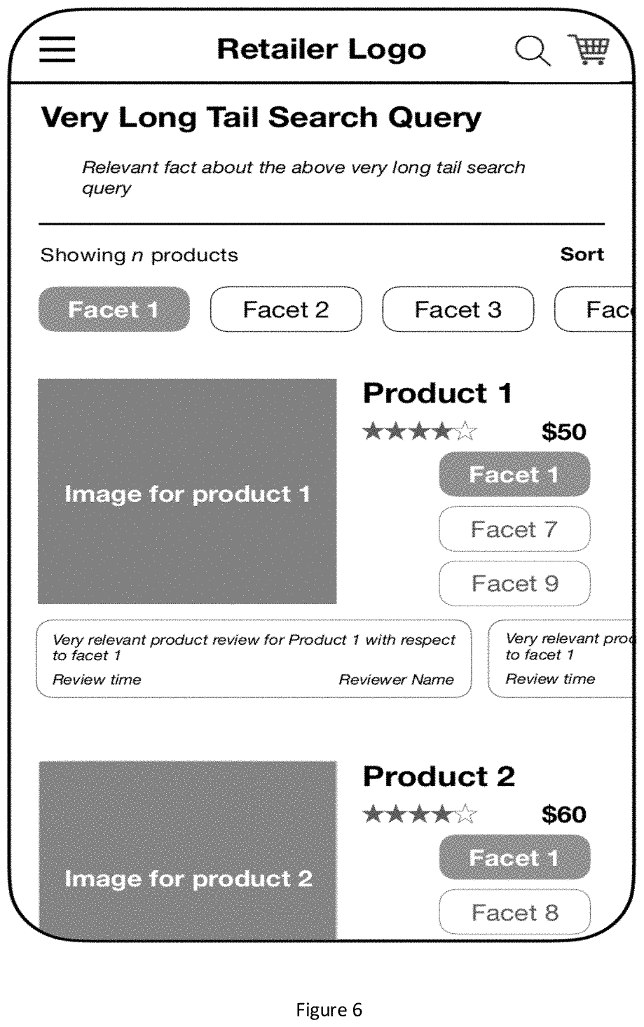

Initially, for a selected query phrase, the system generates a website, which may be seen as a dynamic product listing page including all products that were associated with the query phrase (500). In other words, a webpage is generated as if the long tail query phrase was entered into a search bar. The system then updates the webpage to include selected excerpts or portions of text from the sourced reviews that support the long tail query phrase (502). These selected excerpts are then associated with the products to which the sourced review relates (504). The system may then obtain or purchase ads relating to the generated webpage (506) to capture search engine traffic matching the query phrase. An example of a webpage generated via the method of FIG. 5 is shown in FIG. 6. Alternatively, the system may provide the generated webpage to an e-tailer to purchase the ads. An advantage or novelty of the disclosure is the generation of a webpage (product listing page) with high relevance content (sourced review excerpts or text portions) via these sourced reviews.

In one embodiment, after purchasing an online ad, such as a Google Ad, the Google Ad is associated or linked with the dynamic product listing page website whereby when any user selects or clicks on the Google ad, the dynamic product listing page is displayed, preferably in a separate window.

By combining the processes disclosed above with respect to FIGS. 3 to 5 or FIGS. 5 and 7, many dynamic product listing pages can be generated with each catering to a specific high intent query.

This aspect of the disclosure provides a solution to a longstanding e-commerce problem. Currently, for many search queries with high intent, the resulting links that are displayed to the user lead to a retailer page with low intent. As such, customer (or user) bounce rates are extremely high. The system of the disclosure matches an inbound high intent query with a webpage (or product listing page) with equally high intent and content (the producing listing page with sourced review excerpts).

More than 80% of all Google queries are long tail query phrases that are high intent in nature. However, most current systems typically do not or interact with these high intent queries. Therefore, e-tailers, or retailers, may not engage with up to 80% of all Google queries which means that these e-tailers are missing opportunities to have their products displayed or listed in front of users. Use of the current system may enable improved access to this portion of internet traffic that is currently under-utilized or under-accessed. This will improve the chance of sales for retailers who use the system and methods of the disclosure as they may be presented in more numerous and relevant ways to buyers.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

Applicants reserve the right to pursue any embodiments or sub-embodiments disclosed in this application; to claim any part, portion, element and/or combination thereof of the disclosed embodiments, including the right to disclaim any part, portion, element and/or combination thereof of the disclosed embodiments; or to replace any part, portion, element and/or combination thereof of the disclosed embodiments.

The above-described embodiments are intended to be examples only. Alterations, modifications and variations can be effected to the particular embodiments by those of skill in the art without departing from the scope, which is defined solely by the claims appended hereto.

What is claimed is:

1. A method of generating a dynamic landing page for a product for purchase for e-commerce comprising:
generating an initial page for the product for purchase based on a query phrase;
inserting selected text based on the query phrase;
associating selected text with products; and
obtaining ads based on the generated website.

2. The method of claim 1 wherein generating an initial page based on a query phrase comprises:
generating a long tail query phrase as the query phase.

3. The method of claim 2 wherein generating a long tail query phrase comprises:
receiving a cluster input;
appending a product name to the cluster input to produce the query phrase;
associating consumer products associated with the query phrase; and
validating the query phrase;
wherein the query phrase is a long tail query phrase.

4. The method of claim 3 further comprising:
generating at least one of a traffic or product quality score for the query phrase.

5. The method of claim 3 further comprising, before receiving the cluster input,
retrieving unstructured or structured text associated with the product for purchase;
processing the unstructured or structured text to generate a product for purchase topic;
retrieving other topics associated with the product for purchase topic;
aligning unstructured or structured text with the product for purchase; and
naming a combination of the unstructured or structured text, the product for purchase, the product for purchase topic and the optics associated with the product for purchase topic as the cluster input.

6. The method of claim 5 further comprising storing the combination of the unstructured or structured text, the product for purchase, the product for purchase topic and the optics associated with the product for purchase topic as the cluster input.

7. The method of claim 5 wherein processing the unstructured or structured text comprises processing the unstructured or structured text via topic modeling.

8. The method of claim 1 further comprising, before generating an initial page based on a query phrase:
tracking keywords associated with the product for purchase, where tracking keywords includes performing an initial of the keywords;
generating at least one query phrase in the form of a set of landing page candidates.

9. The method of claim 8 wherein tracking keywords associated with the product for purchase comprises:
scraping website search result pages.

10. The method of claim 8 further comprising:
performing at least one further validation of the keywords if the initial validation does not meet a predetermined level.

11. The method of claim 10 wherein performing at least one further validation of the keywords comprises at least one of performing a validation based on keyword volume; performing a validation based on a level of traffic the keywords have on search engines; performing a validation based on keyword relevance; or performing a validation based on keyword deduplication.
